(19) United States
(12) Patent Application Publication
(10) Pub. No.: US 2008/0096172 A1
(43) Pub. Date: Apr. 24, 2008

(54) Infant Language Acquisition Using Voice Recognition Software

(76) Inventors: Sara Carlstead Brumfield, Austin, TX (US); Kevin John Major, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/462,232

(22) Filed: Aug. 3, 2006

(51) Int. Cl. G09B 19/04

(52) U.S. Cl. 434/185

(57) ABSTRACT

A method and system for recording, cataloging, and analyzing infant speech in order to enhance speech development by producing lists of suggested future words. The invention utilizes voice recognition software to update a database table comprising words that the infant has spoken. Speech analysis software then compares the previously spoken words in the database table to a set of rules, which are used to analyze consonant/vowel patterns and thereby identify trends in word usage. After identifying trends in an infant's word usage, the speech analysis software may then generate reports comprising trends in an infant's word usage and also generate lists of suggested future words for the infant to learn. The computer system then outputs the reports to a display screen, electronic data file, network connection device, or printout.

### BACKGROUND OF THE INVENTION

1. Technical Field

The present invention relates in general to the field of infant speech development and, in particular, to the utilization of software for the purpose of analyzing infant speech patterns. Still more particularly, the present invention relates to an improved method and system for providing feedback regarding trends in word usage and suggesting future words for an infant to learn.

2. Description of the Related Art

Although human language development follows a predictable sequence, there may be a great deal of variation in the ages at which individual infants reach given milestones. Each infant's development is often characterized by the gradual acquisition of particular abilities. For example, use of English verbal inflection may emerge over a period of a year or more, starting from a stage where verbal inflections are always left out, and ending in a stage where verbal inflections are used correctly a majority of the time.

In the first two months after birth, the vocalizations of human infants primarily comprise expressions of discomfort (e.g. crying), along with sounds produced via reflexive actions such as coughing, sucking, swallowing, and burping. During the period from approximately two to four months, infants begin making “comfort sounds” in response to pleasurable interaction with a caregiver. The earliest comfort sounds may include grunts or sighs, while later versions consist of vowel-like “coos”. During the period from about six to eight months, infants often begin “babbling” words with consonant/vowel patterns. This babbling may initially comprise a certain set of consonants, such as “b” and “d”, and then progress to include consonants of increasing complexity, such as “m”. The complexity of an infant's known consonant/vowel patterns thus increases as an infant's speech skills develop over time.

Many different toys have been developed to teach infants the alphabet and simply words such as cat, dog, etc. However most of these toys assume the infant has already developed to an age at which the language skills of the infant would enable the infant to verbalize these words. There is presently no tool or toy that analyzes early infant speech and makes suggestions for further/future infant speech development based on the infant's current level of speech. Consequently, the present invention recognizes that more advanced toys/tools that aid in speech development in infants based on the infants' present/known speech patterns would be a welcomed improvement.

### SUMMARY OF THE INVENTION

Disclosed is a method and system for recording, cataloging, and analyzing infant speech in order to enhance speech development by producing lists of suggested future words. The invention utilizes voice recognition software to update a database comprising words that the infant has spoken. Speech analysis software then compares the previously spoken words in the database table to a set of rules, which are used to analyze consonant/vowel patterns and thereby identify trends in word usage. After identifying trends in an infant's word usage, the speech analysis software may then generate reports comprising trends in an infant's word usage and also generate lists of suggested future words for the infant to learn. The speech analysis software then outputs the reports to a display screen, electronic data file, network connection device, printout, or a toy.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a simplified diagram of an infant's speech being recorded by an electronic toy for analysis via a software program product according to one embodiment of the invention.

FIG. 2 depicts a simplified block diagram of the electronic components within the electronic toy, including a microphone and speaker, as used in an embodiment of the present invention.

FIG. 3 depicts a high level flow chart of the input processes occurring during an implementation of one embodiment of the invention.

FIG. 4 depicts a high level flow chart of the output processes occurring during an implementation of one embodiment of the invention.

### DETAILED DESCRIPTION OF AN ILLUSTRATIVE EMBODIMENT

The present invention provides a method and system for enhancing infant speech development, by providing lists of suggested future words generated through the use of an interactive electronic toy equipped with a software program to record, catalog, and analyze infant speech. As utilized herein, infant speech generally refers to any sounds, words, phrases, and the like that may be vocalized by an infant. Similarly, as utilized herein, user generally refers to an infant's parent, caregiver, older sibling, or other infant speech analyst.

While the invention is described herein with specific interest to developing infant speech, it is understood that the invention may be utilized in more generalized speech applications. For example, the invention is also applicable to assisting speech impaired individuals, such as stroke victims, who are relearning the use vocabulary. Thus the specific references to infant speech and inventive processes to enhance infant speech are not meant to be limiting with respect to the scope of the invention.

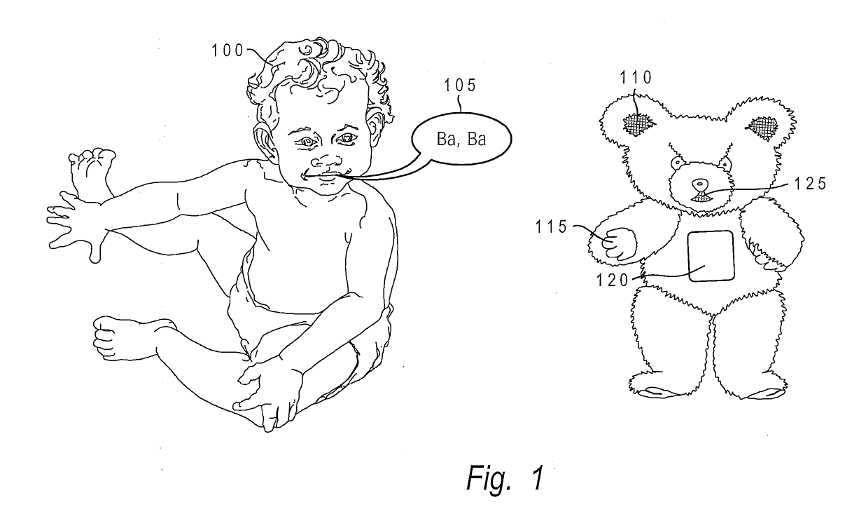

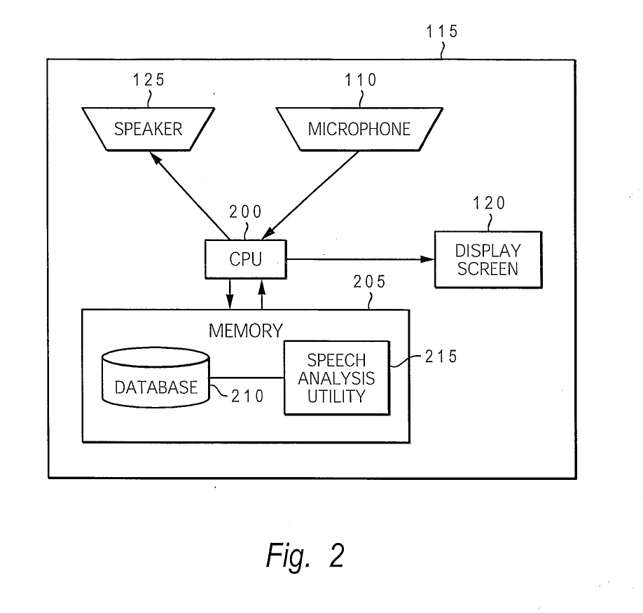

FIG. 1 generally depicts a child/infant 100 interacting with an electronic toy 115. Electronic toy 115 is shown as a teddy bear that comprises microphone 110, display screen 120, and speaker 110. Internal components of electronic toy 115 are illustrated by FIG. 2, which is described below. While electronic toy 115 is illustrated in FIG. 1 as an animal shaped toy, in an alternate embodiment, electronic toy 115 may instead be in the shape of a human doll, cartoon character, or the like. Similarly, while electronic toy 115 is shown in FIG. 1 with microphone 110 located in the ear(s) of the animal shaped toy and speaker 125 located in the mouth of the animal shaped toy, electronic toy 115 could instead be configured with microphone 110 and speaker 125 located in alternate positions on electronic toy 115 and/or located beneath the surface of electronic toy 115 (i.e. not externally visible). In another embodiment, electronic toy 115 could be replaced by a parent-friendly device or computer system having a computer monitor and a peripheral audio input, such as a microphone. Such an embodiment could be used by children and/or adults for advanced language development.

As shown in FIG. 1, infant 100 communicates via infant speech 105. Infant speech 105 is received at microphone 110 and converted into electronic form. Electronic toy 115 then uses speech recognition software to record infant speech 105, which is stored in a database along with date and time information. The infant speech analysis software generates a historical trend report of spoken words and a list of developmentally appropriate suggested future words that are then shown on display screen 120. The output report of a suggested future word or series of words may be communicated to the infant automatically via speaker 125 within electronic toy 115.

In an alternate embodiment, the output report(s) could instead be stored in an electronic data file or sent to an external computer system or printer via a network connected device. In another embodiment, electronic toy 115 might not contain speech analysis software but could instead utilize an external computer system, either directly connected or accessed via a network connected device, to process and analyze infant speech 105 recorded by electronic toy 115. In such an embodiment, the speech analysis and other functional features of the invention are implemented at the external computer system.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

With reference now to FIG. 2, there is depicted a simplified block diagram of one embodiment of example hardware and software components of electronic toy 115. As shown, electronic toy 115 comprises speaker 125, microphone 110, display screen 120, memory 205, and Central Processing Unit (CPU) 200, which is used to process incoming audio signals from microphone 110 and send outgoing audio signals to speaker 125. CPU 200 also interacts with the electronic components of electronic toy 115, such as memory 205 and display screen 120. Memory 205 comprises database 210 and speech analysis utility 215, which acts as an application program to process and analyze the words in database 210 according to a set of predetermined language rules. In an alternate embodiment, database 210 may be a separate component on an internal storage medium, external storage medium, or network accessible on demand. Speech analysis utility 215 also governs the addition of new words to database 210, the sorting of words within database 210, and the selection of output from database 210. While CPU 200 is shown directly connected to display screen 120 and microphone 110, an alternate embodiment of the invention may provide CPU 200 coupled to an independent video driver and/or an independent audio driver, which would then control display screen 120 and/or microphone 110, respectively.

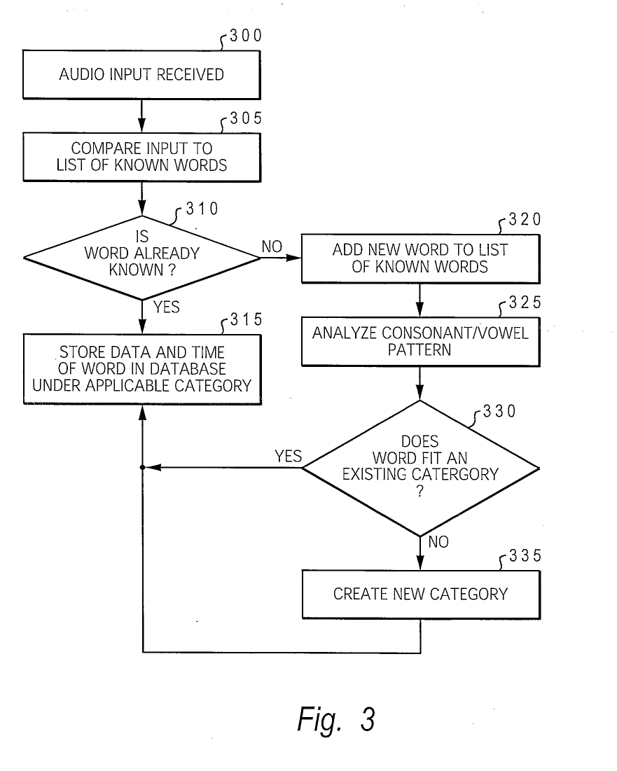

Turning now to FIG. 3, there is depicted a high level flow chart describing the input processes of one embodiment of the present invention for recording, cataloging, and analyzing infant speech 105 from infant 100. As depicted in block 300, infant speech 105 is received by electronic toy 115 as audio input from microphone 110. The speech analysis software then compares infant speech 105 to a list of known words at block 305. A decision is made at block 310, whether infant speech 105 matches a previously known word. If infant speech 105 matches a previously known word, speech analysis utility 215 stores the date and time that the word was spoken by infant 100 within a table in database 210, as depicted in block 315. The table within database 210 is used to store and categorize words that have been spoken by infant 100. Words that have been spoken by infant 100 are placed into categories based on their sounds (both consonant and vowel) and patterns (e.g. consonant, vowel, vowel, consonant, etc.).

If infant speech 105 does not match a previously known word, then infant speech 105 is added to the list of known words within database 210, as depicted in block 320. At block 325, speech analysis utility 215 analyzes the consonant/vowel pattern of the new word in relation to old words with comparable consonant/vowel patterns. At block 330, the speech analysis utility 215 determines whether the new word matches the attributes that characterize any of a plurality of existing word categories. As depicted in block 315, if the new word fits within an existing category speech analysis utility 215 stores the date and time that the word was spoken by infant 100, as well as the word itself, in a table within database 210. If the new word does not fit within an existing category, speech analysis utility 215 creates a new category within the table of words within database 210, as depicted in block 335. Speech analysis utility 215 then proceeds to store the date and time that the word was spoken by infant 100 in the table of words within database 210, as depicted in block 315.

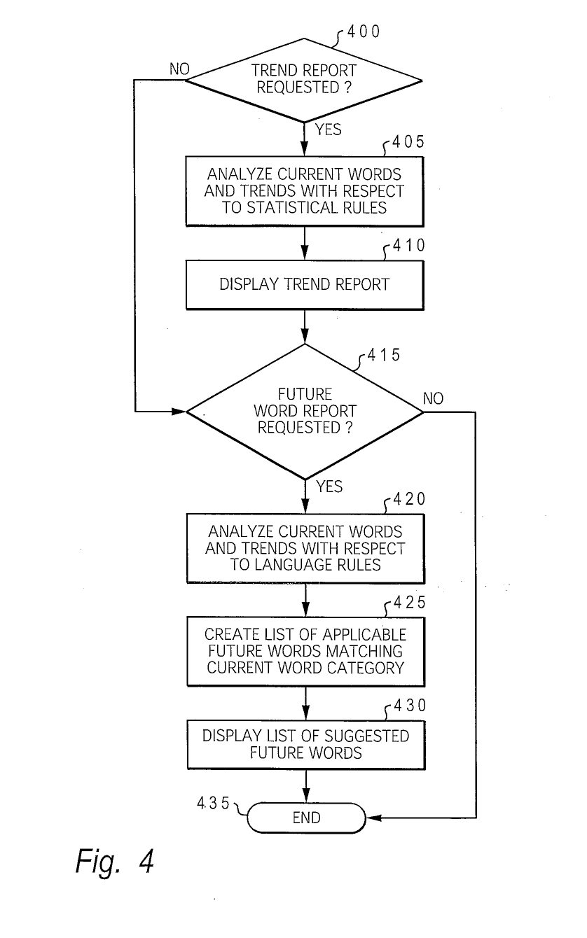

Turning now to FIG. 4, there is depicted a high level flow chart describing the output processes [[of one embodiment of the present invention]] when [[there is]] a user [[that]] later retrieves information from electronic toy 115, according to one embodiment. A decision is made at block 400, whether the user has requested a report of the historical word usage trends (hereinafter called a trend report) of infant 100. If a trend report has been requested, speech analysis utility 215 analyzes the words currently stored in database 210 to determine trends via statistical analysis (e.g. average number of occurrences per word), as shown in block 405. Speech analysis utility 215 then displays the output trend report on display screen 120, as depicted in block 410. As mentioned above, the output report of a suggested future word or series of words may be dynamically/automatically communicated to user and/or audibly communicated to the infant in real time proximate to the time the initial speech of the infant is detected. Such audible communication is enabled via speaker 125 within electronic toy 115. In an alternate embodiment, the output trend report may be sent to an external computer system, stored in an electronic data file, sent to a printer, and/or transmitted to a toy.

Returning to FIG. 4, a decision is made at block 415, whether the user has requested a report of developmentally-appropriate suggested future words. If a report of suggested future words has been requested, speech analysis utility 215 analyzes the words currently stored in database 210 to determine patterns with respect to known language rules, as shown in block 420. Speech analysis utility 215 then generates a list of applicable future words that match the same category of the word most recently spoken by infant 100, as depicted in block 425. At block 430, speech analysis utility 215 displays the output list of suggested future words on display screen 120, before ending the process at block 435. Returning to decision block 415, if a report of suggested future words is not requested, the process terminates at block 435. In alternate embodiments, the output of the suggested future words may be completed via other forms/types of output. For example, the suggested future words report may be sent to an external computer system, stored in an electronic data file, and/or sent to a printer.

It is understood that the use herein of specific names are for example only and not meant to imply any limitations on the invention. The invention may thus be implemented with different nomenclature/terminology utilized to describe the above devices/utility, etc., without limitation.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A speech learning device comprising:
a microphone for receiving words spoken by a speaker;
a database of known words and associated second words having a characteristic similar to the known words, determined based on a historical assessment of linguistic data and pre-established language and speech rules;
processing means for analyzing the received words and determining a second word to suggest to be taught to the speaker based on a linguistic analysis of received word and a comparisons of the received word to a data base of associated words that are identified by the linguistic analysis; and
means for outputting the second word following said determining process.

2. The speech learning device of claim 1, further comprising:
a speech analysis utility, executed by said processing means and which completes the analyzing of the received words, said speech analysis utility further comprising program means for:
evaluating words within the database according to a set of pre-established language rules;
determining when a received word is unknown and adding the unknown received word to the database;
sorting words within the database into a respective set of related words according to the similar characteristic; and
selecting a most appropriate one of said second words from the database as an output.

3. The speech learning device of claim 1, wherein said device is a toy designed for use by a person requiring rudimentary speech development, such as a small infant, said device further comprising:
an external body designed to encourage interaction with the device by the person;
a speaker that audibly verbalizes words as spoken words; and
means for enabling the second word to be audibly outputted by the speaker of the device, wherein the person is provided unequivocal feedback of the second word in response to the person first verbalizing the recorded word.

4. The speech learning device of claim 1, wherein said speech analysis utility further comprises means for:
comparing the infant speech to a list of known words for a match;
when a match is identified within the list of knows words, automatically storing the date and time parameters that the recorded word was spoken by the infant, wherein said parameters are stored within a table in the database, which table is utilized to store and categorize the received words that have been spoken by the infant;
when no match is identified within the list of knows words, adding the infant speech to the list of known words within the database.

5. The speech learning device of claim 1, wherein said processing means for analyzing comprises means for analyzing at least one of a consonant and vowel pattern of the received word and comparing said pattern with pre-stored patterns corresponding to the known words within the database.

6. The speech learning device of claim 1, wherein:
said database further comprises a plurality of existing word categories, each category having attributes that characterize the specific category;
when the recorded word fits within an existing category, said speech analysis utility automatically stores the date and time that the word was spoken by the infant in a table within database, said table pertaining to the applicable category of the known word; and
when the recorded word does not fit within an existing category, said speech analysis utility creates a new category within the table and stored the recorded word within that new category along with the date and time that the word was spoken by the infant.

7. The speech learning device of claim 1, said processing means further comprising:
means for converting speech detected at the microphone into an electronic form;
means for activating speech recognition software to decipher words from within the detected speech;
means for storing the words deciphered in the database along with date and time information of when the speech was detected;
means for generating a historical trend report of spoken words and a list of developmentally appropriate suggested future words; and
means for outputting the list of developmentally appropriate suggested future words.

8. The speech learning device of claim 7, wherein said means for outputting further comprises:
means for storing an output report containing the spoken words and list of developmentally appropriate suggested future words in an electronic data file of the speech learning device; and
means for automatically uploading the output report to a connected processing system having executable processes thereon for outputting the output report.

9. A system for enabling learning of rudimentary speech, said system comprising a processing device, which is coupled to a speech learning device in the form of a toy operating according to claim 10, wherein:
said microphone is located within a toy having electronic storage for storing the received words; and
the database and processing means are components within a processing system to which the toy may be electronically coupled.

10. A method comprising:
receiving, via an audio receiving device, speech spoken by a person;
converting speech received at the audio receiving device into an electronic form;
deciphering a first word from the received speech, said deciphering being completed via a speech recognition component; and
analyzing the first word and determining a second word to suggest to be taught to the person based on a linguistic analysis of the first word and a comparisons of the first word to a database of associated words and category of words that are identified by the linguistic analysis; and
outputting the second word following said analyzing and determining processes.

11. The method of claim 10, further comprising:
evaluating words within the database according to a set of pre-established language rules, said database comprising known words and associated second words having a characteristic similar to the known words, determined based on a historical assessment of linguistic data and pre-established language and speech rules;
determining when a received word is unknown and adding the unknown received word to the database;
sorting words within the database into a respective set of related words according to the similar characteristic;
generating a historical trend report of spoken words and a list of developmentally appropriate suggested future words;
selecting a most appropriate one of said second words from the database as an output, wherein said output is provided via one or more output means from among audible output via a speaker and visible output via a display device; and
wherein said outputting the second word outputs at least one word from the list of developmentally appropriate suggested future words.

12. The method of claim 10, wherein receiving and analyzing are completed within a toy designed for use by a person requiring rudimentary speech development, such as a small infant, said toy comprising:
an external body designed to encourage interaction with the device by the person;
the audio receiving device;
a speaker that audibly verbalizes output words as spoken words;
electronic storage for storing the received word; and
means for enabling the second word to be audibly outputted by the speaker, wherein the person is provided unequivocal feedback of the second word in response to the person first verbalizing the recorded word.

13. The method of claim 12, further comprising:
forwarding the stored received word to an external processing device for completion of said analyzing, wherein the database and processing means are components within a processing system to which the toy is electronically coupled;
wherein said outputting further comprises:
storing an output report containing the spoken words and list of developmentally appropriate suggested future words in an electronic data file of the toy; and
automatically uploading the output report to a connected processing system having executable processes thereon for outputting the output report.

14. The method of claim 12, further comprising:
comparing the infant speech to a list of known words for a match;
when a match is identified within the list of knows words, automatically storing the date and time parameters that the recorded word was spoken by the infant, wherein said parameters are stored within a table in the database, which table is utilized to store and categorize the received words that have been spoken by the infant;
when no match is identified within the list of knows words, adding the infant speech to the list of known words within the database.

15. The method of claim 10, wherein:
said analyzing comprises analyzing at least one of a consonant and vowel pattern of the first word and comparing said pattern with pre-stored patterns corresponding to the known words within the database;
said database further comprises a plurality of existing word categories, each category having attributes that characterize the specific category; and
said method further comprising:
when the first word fits within an existing category, automatically storing the date and time that the first word was spoken by the infant in a table within database, said table pertaining to the applicable category of the known word; and
when the first word does not fit within an existing category, creating a new category within the table and storing the recorded word within that new category along with the date and time that the word was spoken by the infant.

16. A computer program product comprising:
a computer readable medium; and
program code on the computer readable medium, which when executed within a processing device completes at least the first four of the following processes:
receiving, via an audio receiving device, speech spoken by a person;
converting speech received at the audio receiving device into an electronic form;
deciphering a first word from the received speech, said deciphering being completed via a speech recognition component;
analyzing the first word and determining a second word to suggest to be taught to the person based on a linguistic analysis of the first word and a comparisons of the first word to a database of associated words and category of words that are identified by the linguistic analysis; and
outputting the second word following said analyzing and determining processes, wherein said outputting the second word outputs at least one word from a generated list of developmentally appropriate suggested future words.

17. The computer program product of claim 16, wherein said program code for analyzing further comprises code for:
evaluating words within the database according to a set of pre-established language rules, said database comprising known words and associated second words having a characteristic similar to the known words, determined based on a historical assessment of linguistic data and pre-established language and speech rules;
determining when a received word is unknown and adding the unknown received word to the database;
sorting words within the database into a respective set of related words according to the similar characteristic;
generating a historical trend report of spoken words and a list of developmentally appropriate suggested future words; and
selecting a most appropriate one of said second words from the database as an output, wherein said output is provided via one or more output means from among audible output via a speaker and visible output via a display device; and

18. The computer program product of claim 17, wherein:
said receiving and analyzing code are executed within a toy designed for use by a person requiring rudimentary speech development, such as a small infant, said toy comprising:
an external body designed to encourage interaction with the device by the person;
the audio receiving device;
a speaker that audibly verbalizes output words as spoken words;
electronic storage for storing the received word; and
means for enabling the second word to be audibly outputted by the speaker, wherein the person is provided unequivocal feedback of the second word in response to the person first verbalizing the recorded word; and
said method further comprises:
forwarding the stored received word to an external processing device for completion of said analyzing, wherein the database and processing means are components within a processing system to which the toy is electronically coupled;
wherein said outputting further comprises:
storing an output report containing the spoken words and list of developmentally appropriate suggested future words in an electronic data file of the toy; and
automatically uploading the output report to a connected processing system having executable processes thereon for outputting the output report.

19. The computer program product of claim 17, further comprising:
comparing the infant speech to a list of known words for a match;
when a match is identified within the list of knows words, automatically storing the date and time parameters that the recorded word was spoken by the infant, wherein said parameters are stored within a table in the database, which table is utilized to store and categorize the received words that have been spoken by the infant;
when no match is identified within the list of knows words, adding the infant speech to the list of known words within the database.

20. The computer program product of claim 17, wherein:
said code for analyzing comprises code for analyzing at least one of a consonant and vowel pattern of the received word and comparing said pattern with pre-stored patterns corresponding to the known words within the database;
said database further comprises a plurality of existing word categories, each category having attributes that characterize the specific category; and
said program code further comprising code which when executed performs the following processes:
when the first word fits within an existing category, automatically storing the date and time that the first word was spoken by the infant in a table within database, said table pertaining to the applicable category of the known word; and
when the first word does not fit within an existing category, creating a new category within the table and storing the recorded word within that new category along with the date and time that the word was spoken by the infant.
